(19) United States
(12) Patent Application Publication
(10) Pub. No.: US 2009/0218335 A1
(43) Pub. Date: Sep. 3, 2009

(54) Heated Motorcycle Gas Tank Cover

(76) Inventor: Kyie Wallace, Patchogue, NY (US)

Correspondence Address: QUICKPATENTS, INC., 32861 CALLE PERFECTO, SUITE A, SAN JUAN CAPISTRANO, CA, 92675, US

(21) Appl. No.: 12/039,288

(22) Filed: Feb. 28, 2008

(51) Int. Cl. H05B 3/34

(52) U.S. Cl. 219/549

(57) ABSTRACT

A heat-radiating cover is disclosed for a gasoline tank of a motorcycle that has a power source. The cover includes a flexible, heat insulating, substantially water-impermeable lower web that is conformable to the shape of the gasoline tank, being made from either a flexible or malleable material. A flexible middle web includes at least one carbon fiber heating element, each of which are electrically connected to a power cord, a switch, and the power source of the motorcycle. A flexible, heat transmitting, substantially water-impermeable upper web is also conformable to the shape of the gasoline tank, being made from either a flexible or malleable material. A peripheral edge of the upper web is fixed to a peripheral edge of the lower web, such as by stitching, ultrasonic welding, or the like. As such, the at least one carbon fiber heating element is sandwiched between the webs. In use, the power cord is electrically connected to the power source of the motorcycle, and the switch is closed to cause each heating element to warm, the heat radiating up through the upper web but being substantially prevented from radiating down into the gasoline tank by the heat insulating lower web.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to heaters, and more particularly to a heated cover for a motorcycle gasoline tank.

### DISCUSSION OF RELATED ART

Heating devices for motorcycle riders are well known in the art. For example, U.S. Pat. No. 7,178,866 to Scott on Feb. 20, 2007 teaches such a device. Such devices are made to provide warmth to a motorcycle rider when riding in the cold. However, despite the development of many approaches to warming a rider, these approaches often have significant drawbacks.

Using electrically heated clothing is one approach to keep motor cycle riders warm. Electrically heated clothing for motorcycle riding has been around since the 1970s. In particular, electrically heated vests are popular because heating the torso affects the rider's entire body temperature and is less bulky than wearing layers of clothing. However, electrically heated vests have the disadvantage of needing to be connected to a power source which is typically the motorcycle. It is an inconvenience for the rider to be physically connected to the motorcycle. Furthermore, the connecting plugs are often difficult to line up and usually require two hands and some effort to fasten. Wearing heavy gloves in cold weather makes it even more difficult to connect and disconnect the wiring. Moreover, using any electrically heated clothing forces the rider to wear, carry and store such clothing, which can be burdensome. Therefore, a heating device is needed that provides warmth to the motorcycle rider yet does not need to be worn, does not require the rider to be connected to the motorcycle, and does not require to be reconnected with every use.

One approach that gives motorcycle riders more freedom is to put the heating device in the seat of the motorcycle. Both U.S. Pat. No. 7,178,866 to Scott on Feb. 20, 2007 and U.S. Pat. No. 7,183,519 to Horiyama et al. on Feb. 27, 2007 teach electrically heated seats for a motorcycle. Despite the benefits of more freedom provided by these devices, they have some disadvantages. First, the heat is directed at the posterior side of the rider and is not directed towards the torso. Second, these devices teach using heating elements embedded into the seats of motorcycles which would be difficult and expensive to add to existing motorcycles. Therefore, a device is need that directs heat towards the torso of the rider and that can be easily and economically added to existing motorcycles.

A solution is adding a heating device in front of the rider on the fuel tank of the motorcycle. The prior art teaches combining fuel tank covers with other functionality. U.S. Pat. No. 4,469,256 to McEwen on Sep. 4, 1984 teaches a cover with detachable compartments for a motorcycle gas tank. U.S. Pat. No. 4,068,859 to Dittman on Jan. 17, 1978 teaches a combined fuel tank protective cover and thigh grip pad for motorcycles. However, neither of these devices teach combining a fuel tank cover with a heating device. Despite the convenient location of the fuel tank being in front of the rider, the prior art tends to teach away from putting a heating device on the fuel tank due to the risk of igniting the fuel. Therefore, a device is needed that is easily added in front of the motorcycle rider and also protects the safety of the rider.

In addition to providing heat to the rider, such a device would protect the fuel tank from external damage. Fuel tank covers also provide a way for riders to customize and decorate their motorcycle. Therefore, a heat radiating fuel tank cover should also provide the ability to be decorative.

Moreover, the functionality of the motorcycle should not be impeded. Therefore, such a device should use a material that fits closely over the fuel tank to maintain the aerodynamics of the motorcycle. In addition, the amount of power the device needs should not interfere with the performance of the motorcycle. The device should also be waterproof or water-resistant to avoid the possibility of electric shock, particularly when it rains, and to protect both the device itself as well as the fuel tank.

In summary, there is a need for a device that provides warmth to the motorcycle rider yet does not need to be worn, does not require the rider to be connected to the motorcycle, and does not need to be reconnected with every use. The needed device would be easily and economically added in front of the rider on the motorcycle fuel tank and still protect the safety of the rider. The needed device would further function as a fuel tank cover and provide the ability to be decorative. Finally, the needed device would not significantly impede the functionality of the motorcycle. The present invention accomplishes these objectives.

### SUMMARY OF THE INVENTION

The present device is a cover for a gasoline tank of a motorcycle that has a power source. The cover includes a flexible, heat insulating, substantially water-impermeable lower web that is conformable to the shape of the gasoline tank, being made from either a flexible or malleable material. A flexible middle web includes at least one carbon fiber heating element, each of which are electrically connected to a power cord, a switch, and the power source of the motorcycle. A flexible, heat transmitting, substantially water-impermeable upper web is also conformable to the shape of the gasoline tank, being made from either a flexible or malleable material. A peripheral edge of the upper web is fixed to a peripheral edge of the lower web, such as by stitching, ultrasonic welding, or the like. As such, the at least one carbon fiber heating element is sandwiched between the webs.

Preferably the cover further includes at least one tank attachment means adapted for selectively attaching the cover to the gasoline tank. Each tank attachment means is fixed to at least one of the peripheral edges, and may be a mechanical fasting clip, such as a metal or plastic J-shaped clip. The attachment means may alternately be an elastic strap that includes a strap fastener, a non-elastic strap that includes an adjustable strap fastener, or other suitable means for attaching the cover to the gasoline tank.

In use, the power cord is electrically connected to the power source of the motorcycle, and the switch is closed to cause each heating element to warm, the heat radiating up through the upper web but being substantially prevented from radiating down into the gasoline tank by the heat insulating lower web. With gasoline tanks that include a filling cap projecting away from a top surface thereof, each web further includes an aperture therethrough for receiving the filling cap of the gasoline tank therethrough.

The present invention is a heating device for motorcycle riders that provides warmth to the rider yet does not need to be worn, does not require the rider to be connected to the motorcycle, and uses an on/off switch so it does not need to be reconnected with every use. The device is easily and economically added in front of the rider on the motorcycle fuel tank and still protects the safety of the rider by using heating elements that are safe. The present invention uses waterproof and water-resistant parts to avoid the possibility of electric shock and to protect the fuel tank and the device itself. The device further functions as a fuel tank cover, conforming to the shape of the tank and providing the ability to be decorative. Additionally, this device uses low power and does not impede the functionality of the motorcycle. In short, this device provides protection to the fuel tank, to the device itself, and to the rider. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention;

FIG. 2 is a cross-sectional view of the invention, taken generally along lines 2-2 of FIG. 1;

FIG. 3 is a partial cross-sectional view of the invention, taken generally along lines 3-3 of FIG. 2;

FIG. 4 is an exploded perspective view of the invention;

FIG. 5 is a partial close-up view of an attachment means of the invention;

FIG. 6 is partial close-up view of an alternate attachment means of the invention; and

FIG. 7 is a front elevational view of the invention, as attached to a gasoline tank of a motorcycle.

### DETAILED DESCRIPTION OF THE PREFERRED EMBODIMENT

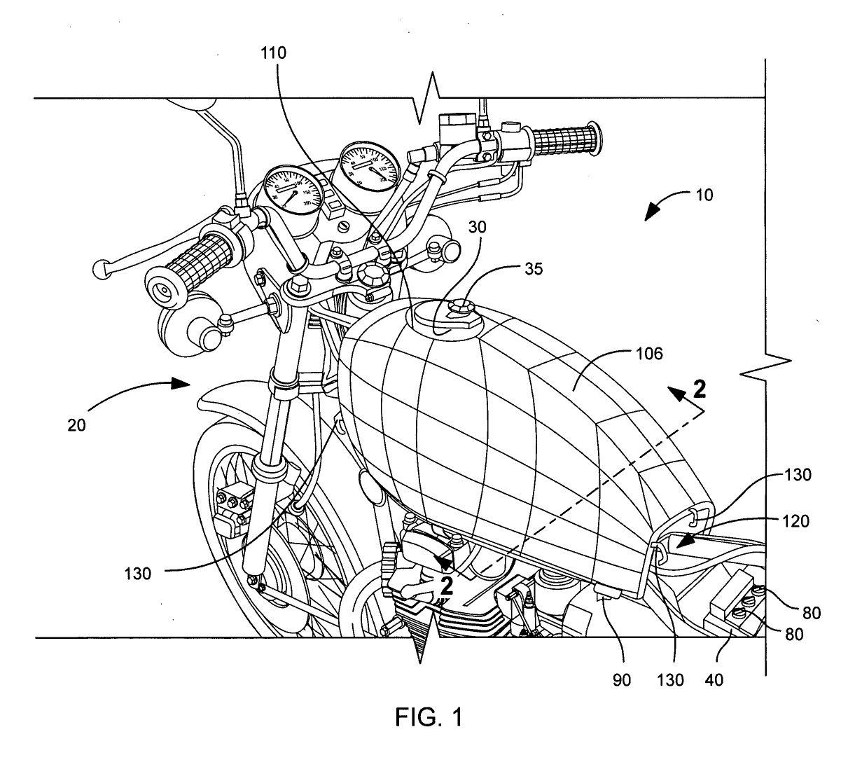

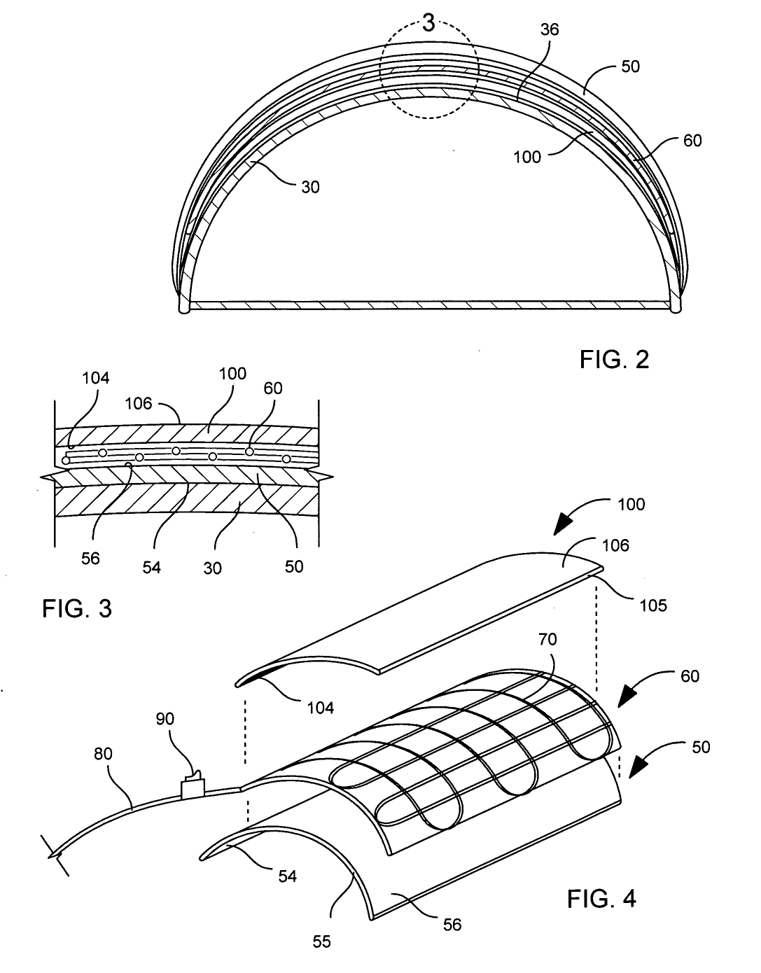

FIGS. 1-4 illustrate a cover 10 for a gasoline tank 30 of a motorcycle 20 that has a power source 40, such as a battery. Such a gasoline tank 30 typically includes a filling cap 35 projecting away from a top surface 36 thereof. The cover 10 includes a flexible, heat insulating, substantially water-impermeable lower web 50 includes a lower surface 54, an upper surface 56, and a peripheral edge 55. The lower web 50 is conformable to the shape of the gasoline tank 30, being made from either a flexible or malleable material. The lower web 50 may be made from a heat-insulating fabric, for example. The lower web 50 may further include a bottom layer of rubber or other water-impermeable material (not shown).

A flexible middle web 60 includes at least one carbon fiber heating element 70, each of which are electrically connected to a power cord 80, a switch 90, and the power source 40 of the motorcycle 20. The switch 90 is electrically disposed between the power source 40 and each heating element 70. The at least one carbon fiber heating element 70 is preferably a grid or mesh of a plurality of such carbon fiber heating elements 70, thereby forming the flexible middle web 60 that also conforms to the shape of the gasoline tank 30.

A flexible, heat transmitting, substantially water-impermeable upper web 100 includes a lower surface 104, an upper surface 106, and a peripheral edge 105 that corresponds to the peripheral edge 55 of the lower web 50. The upper web 100 is also conformable to the shape of the gasoline tank 30, being made from either a flexible or malleable material. Such an upper web 100 may be made from a heat-transmitting polymer material, nylon, or the like. The peripheral edge 105 is fixed to the peripheral edge 55 of the lower web 50, such as by stitching, ultrasonic welding, or the like. As such, the at least one carbon fiber heating element 70 is sandwiched between the webs 50,100. Heat-transmitting cushioning material (not shown) may also be included between the upper and lower webs 100,50 such that the cover 10 has the look and feel of a blanket. The switch 90 and the power cord 80 project away from the webs 50,100 (FIG. 4).

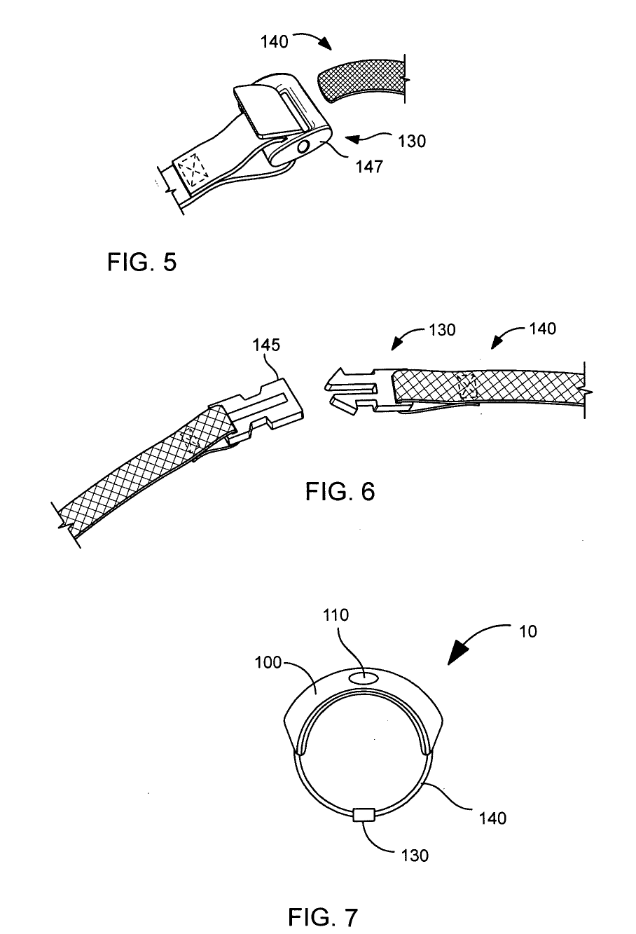

Preferably the cover 10 further includes at least one tank attachment means 120 adapted for selectively attaching the cover 10 to the gasoline tank 40. Each tank attachment means 120 is fixed to at least one of the peripheral edges 55, 105, and may be a mechanical fasting clip 130, such as a metal or plastic J-shaped clip 130 (FIG. 1), an elastic strap 140 that includes a strap fastener 145 (FIG. 6), or a non-elastic strap 140 that includes an adjustable strap fastener 147 (FIG. 5).

In use, the power cord 80 is electrically connected to the power source 40 of the motorcycle 20, and the switch 90 is closed to cause each heating element 70 to warm, the heat radiating up through the upper web 100 but being substantially prevented from radiating down into the gasoline tank 40 by the heat insulating lower web 50. With gasoline tanks 40 that include a filling cap 35 projecting away from a top surface 36 thereof, each web 50, 60, 100 further includes an aperture 110 therethrough for receiving the filling cap 35 of the gasoline tank 40 therethrough.

While a particular form of the invention has been illustrated and described, it will be apparent that various modifications can be made without departing from the spirit and scope of the invention. For example, the size and shape of each web 50,60,100 may be modified to fit any particular brand and model of motorcycle 20. Accordingly, it is not intended that the invention be limited, except as by the appended claims.

What is claimed is:

1. A cover for a gasoline tank of a motorcycle having a power source, comprising:
a flexible, heat insulating, substantially water-impermeable lower web including a lower surface, an upper surface, and a peripheral edge, the lower web conformable to the shape of the gasoline tank;
a flexible middle web comprising at least one carbon fiber heating element, each heating element electrically connected to a power cord, a switch being electrically disposed between the power cord and each heating element; and
a flexible, heat transmitting, substantially water-impermeable upper web including a lower surface, and upper surface, and a peripheral edge corresponding to the peripheral edge of the lower web, the upper web conformable to the shape of the gasoline tank, the peripheral edge thereof fixed to the peripheral edge of the lower web, the at least one carbon fiber heating element sandwiched therebetween, the switch and power cord projecting away therefrom;
whereby with the power cord electrically connected to the power source of the motorcycle, the switch may be closed to cause each heating element to warm.

2. The cover of claim 1 wherein the gasoline tank of the motorcycle includes a filling cap projecting away from a top surface thereof, each web further includes an aperture therethrough for receiving the filling cap of the gasoline tank therethrough.

3. The cover of claim 1 further including at least one tank attachment means fixed to at least one of the peripheral edges and adapted for selectively attaching the cover to the tank.

4. The cover of claim 3 wherein each tank attachment means is a mechanical fastening clip.

5. The cover of claim 3 wherein each tank attachment means is a strap.

6. The cover of claim 5 wherein the strap further includes a strap fastener and wherein the strap is made from an elastic material.

7. The cover of claim 5 wherein the strap further includes an adjustable strap fastener and wherein the strap is made from an inelastic material.
